(19) United States
(12) Patent Application Publication
(10) Pub. No.: US 2024/0365414 A1
(43) Pub. Date: Oct. 31, 2024

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventors: Shun ZHANG, Dongguan (CN); Liuming LU, Dongguan (CN); Lei HUANG, Singapore (SG); Chunlin ZHAO, Dongguan (CN); Yunhan LI, Dongguan (CN); Chaoming LUO, Dongguan (CN)

(21) Appl. No.: 18/670,868

(22) Filed: May 22, 2024

Related U.S. Application Data
(63) Continuation of application No. PCT/CN2021/132120, filed on Nov. 22, 2021.

(51) Int. Cl. H04W 76/15; H04W 88/08

(52) U.S. Cl. CPC H04W 76/15; H04W 88/08

(57) ABSTRACT

Disclosed are a wireless communication method and device. The method is applied to an access point multi-link device AP MLD, where the AP MLD includes at least a first AP and a second AP that are affiliated with the AP MLD, the first AP works on a first link, the second AP works on a second link, and the method includes: sending, by the first AP on the first link, first information to a non-access point non-AP MLD device, where the first information includes at least one piece of target wake time TWT parameter information, and the TWT parameter information is used to determine a TWT SP, where the at least one piece of TWT parameter information is broadcast TWT B-TWT parameter information or restricted TWT R-TWT parameter information, and the at least one piece of TWT parameter information corresponds to at least one link.

### CROSS-REFERENCE TO RELATED APPLICATIONS

This application is a continuation of International Application No. PCT/CN2021/132120, filed on Nov. 22, 2021, the disclosure of which is hereby incorporated by reference in its entirety.

### TECHNICAL FIELD

Embodiments of this application relate to the field of communications, and more specifically, to a wireless communication method and device.

### BACKGROUND

In 802.11ax, a scheduled wake mode for power saving, that is, target wake time (TWT) is proposed. To reduce contention between stations (STA) and an amount of time during which a STA using a power-saving mode needs to be awake, TWT proposes that the STA be awake only during a predefined service period (SP) and perform frame interaction with an access point (AP), and dozes after the SP ends.

To improve communication throughput and/or reliability between devices, a multi-link device (MLD) is introduced. MLDs may perform communication with each other on a plurality of links or a plurality of frequency bands. In this case, how to perform power-saving management is an urgent problem for the MLDs.

### SUMMARY

This application provides a wireless communication method and device, which facilitate power-saving management in a multi-link scenario.

According to a first aspect, a wireless communication method is provided, and the method is applied to an access point multi-link device AP MLD, where the AP MLD includes at least a first AP and a second AP that are affiliated with the AP MLD, the first AP works on a first link, the second AP works on a second link, and the method includes:

sending, by the first AP, first information to a non-access point non-AP MLD device on the first link, where the first information includes at least one piece of target wake time TWT parameter information, and the TWT parameter information is used to determine a TWT SP, where the at least one piece of TWT parameter information is broadcast TWT B-TWT parameter information or restricted TWT R-TWT parameter information, and the at least one piece of TWT parameter information corresponds to at least one link.

According to a second aspect, a wireless communication method is provided, and is applied to a non-access point multi-link device Non-AP MLD, where the non-AP MLD includes at least a first non-AP STA and a second non-AP STA that are affiliated with the non-AP MLD, the first non-AP STA works on a first link, the second non-AP STA works on a second link, and the method includes:

receiving, by the first non-AP STA on the first link, first information sent by an access point AP MLD device, where the first information includes at least one piece of target wake time TWT parameter information, and the TWT parameter information is used to determine a TWT SP, where the at least one piece of TWT parameter information is broadcast TWT B-TWT parameter information or restricted TWT R-TWT parameter information, and the at least one piece of TWT parameter information corresponds to at least one link.

According to a third aspect, an access point multi-link device AP MLD is provided, and is configured to execute the method according to the first aspect or implementations of the first aspect.

Specifically, the AP MLD includes a functional module configured to execute the method according to the first aspect or implementations of the first aspect.

According to a fourth aspect, a non-access point multi-link device Non-AP MLD is provided, and is configured to execute the method according to the second aspect or implementations of the second aspect.

Specifically, the non-AP MLD includes a functional module configured to execute the method according to the second aspect or implementations of the second aspect.

According to a fifth aspect, an access point multi-link device AP MLD is provided, and includes a processor and a memory. The memory is configured to store a computer program, and the processor is configured to invoke and run the computer program stored in the memory to execute the method according to the first aspect or implementations of the first aspect.

According to a sixth aspect, a non-access point multi-link device Non-AP MLD is provided, and includes a processor and a memory. The memory is configured to store a computer program, and the processor is configured to invoke and run the computer program stored in the memory execute the method according to the second aspect or implementations of the second aspect.

According to a seventh aspect, a chip is provided, and is configured to implement the method according to any one of the first aspect and the second aspect or implementations of the first aspect and the second aspect.

Specifically, the chip includes a processor, configured to invoke a computer program from a memory and run the computer program, to cause a device on which the chip is installed to execute the method according to any one of the first aspect and the second aspect or implementations of the first aspect and the second aspect.

According to an eighth aspect, a computer-readable storage medium is provided, and is configured to store a computer program, where the computer program causes a computer to execute the method according to any one of the first aspect and the second aspect or implementations of the first aspect and the second aspect.

According to a ninth aspect, a computer program product is provided, and includes computer program instructions, where the computer program instructions cause a computer to execute the method according to any one of the first aspect and the second aspect or implementations of the first aspect and the second aspect.

According to a tenth aspect, a computer program is provided, and when the computer program runs on a computer, the computer executes the method according to any one of the first aspect and the second aspect or implementations of the first aspect and the second aspect.

By using the foregoing technical solutions, an AP affiliated with an AP MLD may send, on a link, first information to a STA affiliated with a non-AP MLD, where the first information includes TWT parameter information corresponding to at least one link. Therefore, the non-AP MLD may determine a TWT SP of the at least one link according to the TWT parameter information, thereby facilitating power-saving management in a multi-link scenario.

### BRIEF DESCRIPTION OF DRAWINGS

FIG. 1 is a schematic diagram of an architecture of a communications system according to an embodiment of this application.

FIG. 2 is a schematic diagram of a system architecture to which an embodiment of this application is applied.

FIG. 3 is a diagram of an example of a broadcast TWT operation.

FIG. 4 is a schematic diagram of interaction in a wireless communication method according to an embodiment of this application.

FIG. 5 is a schematic diagram of a format of a B-TWT element according to an embodiment of this application.

FIG. 6 is a schematic diagram of a format of a TWT parameter information field according to an embodiment of this application.

FIG. 7 is a schematic diagram of a multi-link operation method according to an embodiment of this application.

FIG. 8 is a schematic diagram of another multi-link operation method according to an embodiment of this application.

FIG. 9 is a schematic diagram of another link operation method according to an embodiment of this application.

FIG. 10 is a schematic diagram of another multi-link operation method according to an embodiment of this application.

FIG. 11 is a schematic diagram of another multi-link operation method according to an embodiment of this application.

FIG. 12 is a schematic diagram of another multi-link operation method according to an embodiment of this application.

FIG. 13 is a schematic diagram of another multi-link operation method according to an embodiment of this application.

FIG. 14 is a schematic block diagram of an access point multi-link device according to an embodiment of this application.

FIG. 15 is a schematic block diagram of a non-access point multi-link device according to an embodiment of this application.

FIG. 16 is a schematic block diagram of a communications device according to an embodiment of this application.

FIG. 17 is a schematic block diagram of a chip according to an embodiment of this application.

FIG. 18 is a schematic block diagram of a communications system according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. For embodiments of this application, all other embodiments obtained by a person of ordinary skill in the art without creative efforts fall within the protection scope of this application.

The technical solutions in embodiments of this application may be applied to various communications systems, for example, wireless local area network (WLAN), wireless fidelity (WiFi), or another communications system.

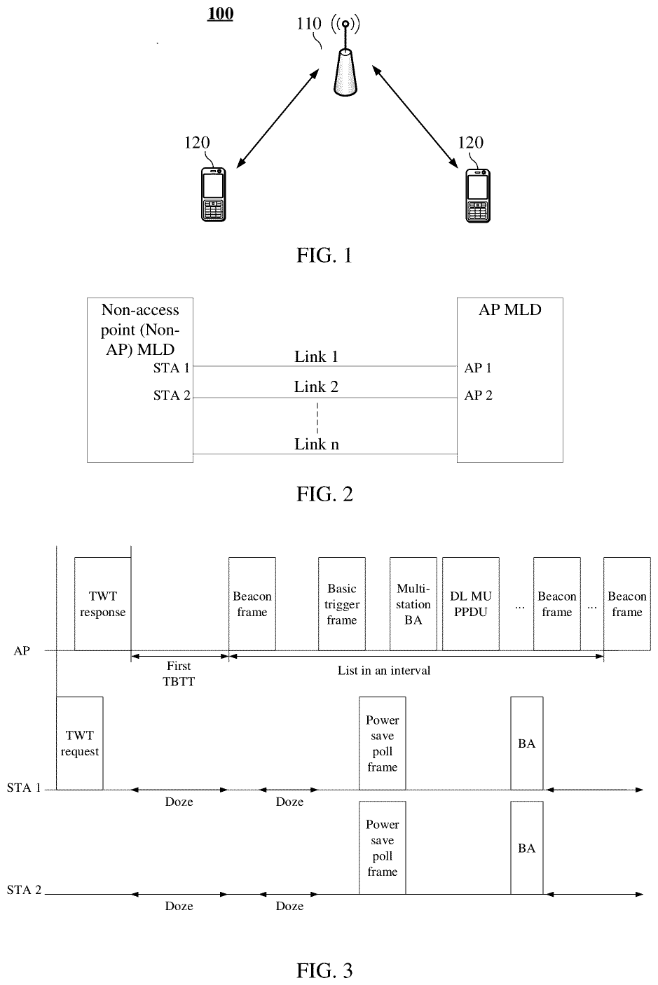

For example, a communications system 100 to which an embodiment of this application is applied is shown in FIG. 1. The communications system 100 may include an access point (AP) 110 and stations (STA) 120 that access a network by using the access point 110.

In some scenarios, an AP is referred to as an AP STA. That is, in a sense, the AP is also a STA.

In some scenarios, a STA is referred to as a non-AP STA.

Communication in the communications system 100 may be communication between an AP and a non-AP STA, or may be communication between a non-AP STA and a non-AP STA, or communication between a STA and a peer STA, where the peer STA may refer to a device that performs peer-to-peer communication with the STA, for example, the peer STA may be an AP, or may be a non-AP STA.

An AP is equivalent to a bridge that connects a wired network and a wireless network. A major function of the AP is to connect clients in the wireless network together and then connect the wireless network to an Ethernet. The AP device may be a terminal device (for example, a mobile phone) or a network device (for example, a router) that has a Wi-Fi chip.

It should be understood that a role of a STA in a communications system is not fixed. For example, in some scenarios, when a mobile phone is connected to a route, the mobile phone is a non-AP STA; when the mobile phone serves as a hotspot of another mobile phone, the mobile phone serves as an AP.

An AP and a non-AP STA may be devices applied in vehicle-to-everything, an internet of things node, a sensor, or the like in internet of things (IoT), an intelligent camera in smart home, an intelligent remote control, an intelligent water meter, an intelligent electricity meter, and a sensor in smart city.

In some embodiments, the non-AP STA may support an 802.11be standard. The non-AP STA may also support a plurality of current and future wireless local area network (WLAN) standards of an 802.11 family, such as 802.11ax, 802.11ac, 802.11n, 802.11g, 802.11b, and 802.11a.

In some embodiments, the AP may be a device that supports the 802.11be standard. The AP may also be a device that supports a plurality of current and future WLAN standards of the 802.11 family, such as 802.11ax, 802.11ac, 802.11n, 802.11g, 802.11b, and 802.11a.

In embodiments of this application, the STA may be a device that supports a WLAN or Wi-Fi technology, such as a mobile phone, a pad, a computer, a virtual reality (VR) device, an augmented reality (AR) device, a wireless device in industrial control, a set-top box, a wireless device in self-driving, an in-vehicle communications device, a wireless device in remote medical, a wireless device in smart grid, a wireless device in transportation safety, a wireless device in smart city, a wireless device in smart home, a wireless communications chip, an ASIC, a SOC, or the like.

Frequency bands supported by the WLAN technology may include but are not limited to a low frequency band (such as 2.4 GHZ, 5 GHZ, or 6 GHZ) and a high frequency band (for example, 60 GHz).

FIG. 1 exemplarily shows one AP STA and two non-AP STAs. Optionally, the communications system 100 may include a plurality of AP STAs and another quantity of non-AP STAs. This is not limited in embodiments of this application.

It should be understood that in this embodiment of this application, a device having a communication function in a network or a system may be referred to as a communications device. The communications system 100 shown in FIG. 1 is used as an example. A communications device may include the access point 110 and the stations 120 that have a communication function. The access point 110 and the stations 120 may be specific devices described above. Details are not described herein again. The communications device may further include another device in the communications system 100, such as a network controller and a gateway, which is not limited in this embodiment of this application.

It should be understood that the terms “system” and “network” may often be used interchangeably herein. In this specification, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

It should be understood that, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In the description of embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” may be implemented by pre-storing corresponding code or a table in a device (for example, including the access point and the stations) or in other manners that can be used for indicating related information, and a specific implementation thereof is not limited in this application. For example, pre-defining may refer to being defined in a protocol.

A wireless device supports multi-band communication, for example, simultaneous communication on frequency bands such as 2.4 GHZ, 5 GHZ, 6 GHZ, and 60 GHz, or simultaneous communication on different channels of a same frequency band (or different frequency bands). This improves communication throughput and/or reliability between devices. This type of device is generally referred to as a multi-band device, or is referred to as a multi-link device (MLD), and sometimes is also referred to as a multi-link entity or a multi-band entity. The multi-link device may be an access point device, or may be a station device. If the multi-link device is an access point device, the multi-link device includes one or more APs. If the multi-link device is a station device, the multi-link device includes one or more non-AP STAs.

A multi-link device that includes one or more APs is referred to as an AP MLD, and a multi-link device that includes one or more non-AP STAs is referred to as a non-AP MLD. In this embodiment of this application, the non-AP MLD may be referred to as a STA MLD.

In this embodiment of this application, the AP MLD may include a plurality of APs, and the non-AP MLD includes a plurality of STAs. A plurality of links may be formed between the APs in the AP MLD and the STAs in the non-AP MLD, and data communication may be performed between an AP in the AP MLD and a corresponding STA in the non-AP MLD by using a corresponding link.

As shown in FIG. 2, an AP MLD may include an AP 1, an AP 2, and the like. A non-AP MLD includes a STA 1, a STA 2, and the like. A link 1 is formed between the AP 1 and the STA 1, a link 2 is formed between the AP 2 and the STA 2, and the like. The AP 1 and the STA 1 may perform data communication with each other by using the link 1, and the AP 2 and the STA 2 may perform data communication with each other by using the link 2.

To facilitate understanding of the technical solutions in embodiments of this application, the following describes broadcast target wake time (B-TWT) related to this application.

TWT is a scheduled wake mode for power saving proposed in 802.11ax. To reduce contention between STAs and an amount of time during which a STA using a power-saving mode needs to be awake, TWT proposes that the STA be awake only during a predefined service period (SP) and performs frame interaction with an AP, and dozes after the SP ends.

Broadcast TWT is a power-saving TWT mode managed by an AP. In B-TWT, there are interaction actions of joining a group and leaving a group, and a STA needs to apply to the AP to join a group, so as to execute B-TWT. An interaction action of joining a group is completed by carrying a TWT element in a management frame used for interacting with the AP. After the STA completes joining the group, the STA works according to a recently received TWT service period. In this case, this type of STA is also referred to as a “TWT scheduled STA”, and the AP is referred to as a “TWT scheduling AP”. In this mechanism, the TWT SP is announced by the AP, and usually the AP announces a TWT SP of a current round in each beacon frame. After the TWT SP starts, STAs wake up, and the AP sends a broadcast trigger frame, to discover STAs that are in a wake-up state, and sends a data frame to the STAs. After the AP completes the sending, the STAs enter a doze state until a time of next broadcast TWT arrives.

FIG. 3 is an example of an operation process of a broadcast TWT mechanism (having an example of a broadcast TWT operation with optional TBTT negotiation), where an AP is a TWT scheduling AP, and a STA 1 and a STA 2 are TWT scheduled STAs.

Specifically, the TWT scheduling AP adds a broadcast TWT element (or referred to as a B-TWT element) in a beacon frame, where the B-TWT element indicates a B-TWT SP, and the AP intends to send a trigger frame or downlink data to the TWT scheduled STAs within the B-TWT SP. Within the B-TWT SP, the STA 1 and the STA 2 wake up to receive the beacon frame of the AP, so as to determine the B-TWT SP. Within the TWT SP with the trigger frame enabled, the AP sends a basic trigger frame. When the STA 1 and the STA 2 receive the basic trigger frame, it indicates that the STA 1 and the STA 2 need to be awake during the TWT SP. The STA 1 indicates that it is in a wake-up state by sending a power save poll (PS-Poll), and the STA 2 indicates that it is in the wake-up state by sending a quality of service (QOS) null frame. The STA 1 and the STA 2 receive temporarily stored downlink data of the AP in subsequent interaction with the AP, and enter a doze state after the TWT SP ends.

To facilitate understanding of the technical solutions in embodiments of this application, the following describes a mobile AP related to this application.

Due to features such as a low cost, flexibility, and easy expansion, a wireless local area network is widely used in scenarios such as enterprises, homes, and the like. Currently, a wireless product named “mobile access point (Mobile AP)” is very common in a market. Since no dedicated AP needs to be deployed, the mobile AP can set up a wireless network at almost any required location with a relatively low cost. The mobile AP is particularly suitable for providing an economical and fast networking mode for a small quantity of users in small offices and home environments, and is also applicable to places that require temporary networking, such as construction sites, exhibitions, and sports meets.

In a multi-link part of an 802.11be standard draft, an operation mechanism for a non-simultaneous transmit and receive (NSTR) AP MLD is proposed. A specific example is a mobile AP MLD. This type of mobile AP MLD is usually located in a mobile device powered by a battery. For such a mobile AP MLD, a most common use case is a Wi-Fi hotspot or network sharing.

Links provided by the mobile AP MLD include a primary link and a non-primary link (a secondary link). The mobile AP MLD communicates with a traditional device or a single-link device only on the primary link. An MLD may communicate with the mobile AP MLD on the primary link and the non-primary link. To ensure transmission quality of the traditional device and the single-link device, if the mobile AP MLD needs to perform transmission on the non-primary link, the mobile AP MLD must be a transmission opportunity (TXOP) holder on the primary link. Further, for a non-AP MLD associated with the mobile AP MLD, only when an affiliated STA of the non-AP MLD initiates transmission of a physical layer protocol data unit (PPDU) on the primary link as a TXOP holder, another affiliated STA of the non-AP MLD can initiate PPDU transmission on the non-primary link.

Because the mobile AP MLD has an NSTR feature, for the mobile AP MLD, how to perform multi-link power-saving management is an urgent problem to be resolved.

To facilitate understanding of the technical solutions in embodiments of this application, the following describes the technical solutions in this application in detail by using specific embodiments. The foregoing related technologies, as optional solutions, may be randomly combined with the technical solutions of embodiments of this application, all of which fall within the protection scope of embodiments of this application. Embodiments of this application include at least a part of the following content.

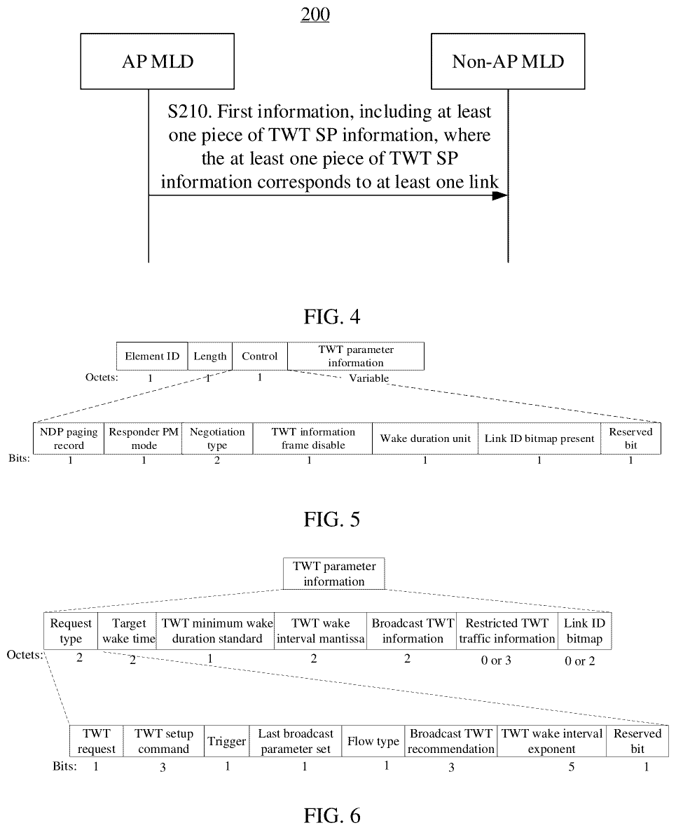

FIG. 4 is a schematic diagram of interaction in a wireless communication method 200 according to an embodiment of this application. The method 200 is applied to interaction between an AP MLD and a non-AP MLD.

The AP MLD includes at least a first AP and a second AP that are affiliated with the AP MLD, the first AP works on a first link, and the second AP works on a second link. Correspondingly, the non-AP MLD includes at least a first non-AP STA and a second non-AP STA that are affiliated with the non-AP MLD, the first non-AP STA works on the first link, and the second non-AP STA works on the second link.

That is, the first AP affiliated with the AP MLD may perform frame interaction with the first non-AP STA affiliated with the non-AP MLD on the first link, and the second AP affiliated with the AP MLD may perform frame interaction with the second non-AP STA affiliated with the non-AP MLD on the second link.

In this embodiment of this application, the first AP and the second AP are referred to as affiliated APs of the AP MLD.

In this embodiment of this application, the first non-AP STA and the second non-AP STA are referred to as affiliated STAs of the non-AP MLD.

In this embodiment of this application, a non-AP STA is referred to as a STA.

It should be understood that a quantity of APs included in the AP MLD and a quantity of non-AP STAs included in the non-AP MLD in the foregoing are merely examples. The AP MLD may further include more APs, and the non-AP MLD may further include more non-AP STAs. This is not limited in this application.

It should be understood that in this embodiment of this application, the AP MLD may be any AP MLD, for example, may include an NSTR AP MLD, as an example mobile AP MLD, or may include an STR AP MLD, which is not limited in this application.

In some embodiments, the non-AP MLD may be a TWT request end, and the AP MLD may be a TWT response end.

Optionally, the AP MLD may set TWT SP information corresponding to at least one link based on a request of the non-AP MLD, or based on negotiation with the non-AP MLD.

As shown in FIG. 4, the method 200 includes at least a part of the following content: S210. The first AP sends first information to the non-AP MLD on the first link, where the first information includes at least one piece of target wake time TWT parameter information.

Specifically, S210 may include:
sending, by the first AP on the first link, the first information to the first non-AP STA affiliated with the non-AP MLD.

Optionally, the TWT parameter information may be broadcast TWT parameter information, which is used to determine a B-TWT SP.

Optionally, the TWT parameter information may be restricted TWT parameter information, which is used to determine an R-TWT SP.

In this embodiment of this application, the at least one piece of TWT parameter information corresponds to at least one link. That is, the at least one piece of TWT parameter information is used to determine a TWT SP on the at least one link.

Therefore, in this embodiment of this application, an affiliated AP of the AP MLD may carry, on one link, TWT parameter information of one or more links, which facilitates power-saving management on a plurality of links. In other words, the technical solution in this embodiment of this application may implement TWT settings or TWT operations of the plurality of links.

In some embodiments, within duration of a TWT SP of a link, a non-AP STA in the non-AP MLD that is on the link is in a wake-up state, and an AP in the AP MLD that is on the link is in the wake-up state.

Optionally, after the TWT SP of the link ends, the non-AP STA in the non-AP MLD that is on the link enters a doze state, and the AP in the AP MLD that is on the link enters the doze state.

In some embodiments of this application, TWT parameter information includes but is not limited to at least one of the following:
a start time of a TWT SP;
information about a time interval between TWT SPs;
whether a trigger frame needs to be sent, or in other words, whether a TWT SP is trigger-based;
whether a non-AP STA in the non-AP MLD needs to respond to a power save poll (PS-Poll) frame or an automatic power save delivery (APSD) frame within duration of a TWT SP of a link; and
a type of a frame recommended by the AP MLD for sending within duration of a TWT SP of a link.

It should be understood that the foregoing content included in TWT parameter information is merely an example, and the TWT parameter information may further include other information used to determine the TWT SP, for example, information carried in a TWT parameter field in the following, which is not limited in this application.

In some embodiments, if the TWT SP is trigger-based, a trigger frame needs to be sent at least once before the TWT SP starts.

In some embodiments, that the at least one piece of TWT parameter information corresponds to at least one link may include:

the at least one link corresponds to one piece of TWT parameter information, that is, the at least one link corresponds to a same piece of TWT parameter information.

That is, the TWT SP on the at least one link is the same.

In some other embodiments, that the at least one piece of TWT parameter information corresponds to at least one link may include:

the at least one link is in one-to-one correspondence with the at least one piece of TWT parameter information, that is, each link corresponds to independent TWT parameter information.

In this case, a TWT SP on each link may be the same, or may be different.

In some other embodiments, the at least one link includes a plurality of links, and that the at least one piece of TWT parameter information corresponds to at least one link may include:

some links in the at least one link correspond to independent TWT parameter information, and the other links correspond to same TWT parameter information.

That is, the at least one link and the at least one piece of TWT parameter information may be in one-to-one correspondence or many-to-one correspondence, or some of the at least one link and some of the at least one piece of TWT parameter information may be in one-to-one correspondence, and the other of the at least one link and the other of the at least one piece of TWT parameter information may be in many-to-one correspondence.

In some embodiments, the AP MLD is a mobile AP MLD, and the first link is a primary link.

That is, the affiliated AP of the mobile AP MLD that is on the primary link may send the first information to the first non-AP STA in the non-AP MLD that is on the primary link.

In some embodiments, the first information includes TWT parameter information corresponding to the primary link. Alternatively, the first information includes TWT parameter information corresponding to the primary link and TWT parameter information corresponding to at least one secondary link.

That is, the at least one link corresponding to the at least one piece of TWT parameter information may include a primary link, or may include a primary link and at least one secondary link. Therefore, the mobile AP MLD may perform power-saving management on the primary link by using the primary link, or perform power-saving management on the primary link and the secondary link by using the primary link.

For example, the first AP affiliated with the mobile AP MLD that is on the primary link may send the first information to the first non-AP STA in the non-AP MLD that is on the primary link, where the first information includes the TWT parameter information corresponding to the primary link and the TWT parameter information corresponding to the at least one secondary link. Therefore, the mobile AP MLD may determine, according to the first information, a TWT SP on the primary link and a TWT SP on the at least one secondary link.

It should be understood that a quantity of links between the mobile AP MLD and the non-AP MLD associated with the mobile AP MLD is not limited in this embodiment of this application. For example, there may be two links, or there may be more links.

In this embodiment of this application, the secondary link may also be referred to as a non-primary link, and the two terms may be replaced with each other.

In some embodiments of this application, the first information further includes first indication information, where the first indication information is used to indicate a target link corresponding to the at least one piece of TWT parameter information; or the first indication information is used to indicate a target link that needs to be started in a multi-link operation, that is, the foregoing at least one link.

In other words, the first indication information is used to indicate a link on which the AP MLD sets a TWT SP, or a link on which the AP MLD schedules a TWT SP.

For the non-AP MLD, the affiliated first non-AP STA may determine, according to the first indication information, a target link on which the AP MLD sets TWT SP information, and further determine, based on TWT parameter information corresponding to the target link, a TWT SP (for example, a start location and duration) corresponding to the target link. Then, the affiliated STA of the non-AP MLD that is on the target link may wake up at the start location of the TWT SP on the target link, and perform frame interaction with an AP in the AP MLD that is on the target link. After an end location of the TWT SP or after the frame interaction is completed, the non-AP STA in the non-AP MLD that is on the target link and the AP in the AP MLD that is on the target link enter a doze state, and a current TWT SP ends, or current TWT SP scheduling ends.

In some embodiments, the first indication information is used to indicate link ID information corresponding to at least one link.

In some embodiments, the first indication information includes link ID information of a link to which each piece of TWT parameter information in the first information is applied.

In some embodiments, the AP MLD indicates, in a bitmap manner, the target link corresponding to the at least one piece of TWT parameter information, or indicates, in a bit map manner, a link on which the AP MLD sets a TWT SP.

For a target link on which a TWT SP is set, the first information includes TWT parameter information corresponding to the target link.

For example, the first indication information includes a first bitmap, the first information includes first TWT parameter information, and the first bitmap corresponds to the first TWT parameter information, that is, the first bitmap is used to indicate a target link to which the first TWT parameter information is applied.

Optionally, the first bitmap includes a plurality of bits, each bit corresponds to a link ID, and a value of each bit is used to indicate whether the first TWT parameter information is applied to a link indicated by a corresponding link ID, or a value of each bit is used to indicate whether the AP MLD sets TWT parameter information of a link indicated by a corresponding link ID. For example, a value of 0 indicates that the first TWT parameter information is not applied to the corresponding link, and a value of 1 indicates that the first TWT parameter information is applied to the corresponding link.

As an example, there are three links between the AP MLD and the non-AP MLD: a link 1, a link 2, and a link 3. If the AP MLD schedules TWT SPs of the three links, and sets a same TWT SP for the three links, the first information may include one piece of TWT parameter information, and the first bitmap may be 111, which is used to indicate that the one piece of TWT parameter information is applied to the link 1, the link 2, and the link 3.

In another example, there are three links between the AP MLD and the non-AP MLD: a link 1, a link 2, and a link 3. If the AP MLD schedules TWT SPs of the three links, where the link 1 and the link 2 are scheduled to correspond to a same TWT SP, and the link 3 is scheduled to correspond to a separate TWT SP, the first information includes the first TWT parameter information and second TWT parameter information, where the first TWT parameter information corresponds to the link 1 and the link 2, and the second TWT parameter information corresponds to the link 3. In this case, the first information includes the first bitmap and a second bitmap, the first bitmap corresponds to the first TWT parameter information, and the second bitmap corresponds to the second TWT parameter information. For example, a value of the first bitmap is 011, which is used to indicate that the first TWT parameter information is applied to the link 1 and the link 2, but is not applied to the link 3. A value of the second bitmap is 100, which is used to indicate that the second TWT parameter information is not applied to the link 1 and the link 2, but is applied to the link 3.

In some embodiments of this application, the first information is carried in a broadcast B-TWT element.

In this embodiment of this application, TWT parameter information carried in the B-TWT element may be referred to as B-TWT parameter information. Correspondingly, a TWT SP determined according to the B-TWT parameter information may be referred to as a B-TWT SP.

In some embodiments of this application, the B-TWT element is carried in a first frame.

For example, the first frame may be a beacon frame, or may be a management frame. That is, the B-TWT element may be carried by using the beacon frame or the management frame, where the B-TWT element is used to carry the first information.

Optionally, the management frame may include but is not limited to at least one of the following:

a probe response frame, an association response frame, and a reassociation response frame.

In some embodiments, the first frame includes one or more B-TWT elements, where the B-TWT element is used to carry B-TWT parameter information.

Optionally, the B-TWT parameter information carried in each B-TWT element may correspond to one link, or may correspond to a plurality of links. That is, the AP MLD may indicate, by using one B-TWT element, B-TWT parameter information corresponding to one link, or may indicate, by using one B-TWT element, B-TWT parameter information corresponding to a plurality of links.

In some embodiments, the B-TWT element includes a TWT parameter information field, where the TWT parameter information field is used to carry the B-TWT parameter information. A parameter carried in the TWT parameter information field of the B-TWT element is referred to as a B-TWT parameter set.

In some embodiments, the B-TWT element further includes a link ID bitmap field, and the link ID bitmap field is used to indicate a target link to which the B-TWT parameter information indicated by the TWT parameter information field in the B-TWT element is applied.

For example, the link ID bitmap field may be used to carry the foregoing first bitmap, the foregoing second bitmap, or the like.

In some embodiments, the B-TWT element further includes a control field, where the control field includes a link ID bitmap present field, which is used to indicate whether the B-TWT element includes the link ID bitmap field, or whether the TWT parameter information field includes the link ID bitmap field.

Optionally, when the link ID bitmap present field indicates that the link ID bitmap field exists, it indicates that an application scenario of current transmission is broadcast TWT in a multi-link scenario.

Optionally, when the control field of the B-TWT element includes the link ID bitmap present field, the control field may be considered as a multi-link control field. Correspondingly, the B-TWT element may be considered as a multi-link B-TWT element.

In some embodiments of this application, the first information is carried in a restricted TWT element (R-TWT element).

In this embodiment of this application, TWT parameter information carried in the R-TWT element may be referred to as R-TWT parameter information. Correspondingly, a TWT SP determined according to the R-TWT parameter information may be referred to as an R-TWT SP.

In some embodiments of this application, the R-TWT element may also be carried in the first frame.

In some embodiments, the first frame includes one or more R-TWT elements, where the R-TWT element is used to carry R-TWT parameter information.

Optionally, the R-TWT parameter information carried in each R-TWT element may correspond to one link, or may correspond to a plurality of links. That is, the AP MLD may indicate, by using one R-TWT element, R-TWT parameter information corresponding to one link, or may indicate, by using one R-TWT element, R-TWT parameter information corresponding to a plurality of links.

In some embodiments, the R-TWT element includes a TWT parameter information field, where the TWT parameter information field is used to carry the R-TWT parameter information. A parameter carried in the TWT parameter information field is referred to as an R-TWT parameter set.

In some embodiments, the R-TWT element further includes a link ID bitmap field, and the link ID bitmap field is used to indicate a target link to which the R-TWT parameter information indicated by the TWT parameter information field in the R-TWT element is applied.

For example, the link ID bitmap field may be used to carry the foregoing first bitmap, the foregoing second bitmap, or the like.

In some embodiments, the R-TWT element further includes a control field, where the control field includes a link ID bitmap present field, which is used to indicate whether the R-TWT element includes the link ID bitmap field, or whether the TWT parameter information field includes the link ID bitmap field.

Optionally, when the link ID bitmap present field indicates that the link ID bitmap field exists, it indicates that an application scenario of current transmission is restricted TWT in a multi-link scenario.

Optionally, when the control field of the R-TWT element includes the link ID bitmap present field, the control field may be considered as a multi-link control field. Correspondingly, the R-TWT element may be considered as a multi-link R-TWT element.

It should be understood that, in this embodiment of this application, a format of the R-TWT element is similar to that of the B-TWT element. A difference lies in that values of fields are different. The following uses a B-TWT element as an example for description, and is also applicable to an R-TWT element.

FIG. 5 is a diagram of a format of a B-TWT element according to an embodiment of this application.

It should be understood that a structure of the B-TWT element in FIG. 5, and a length and a location of each field included in the B-TWT element are merely examples. In actual application, the structure may be adjusted according to a specific requirement, which is not limited in this application.

It should also be understood that a relationship between values of the following fields and corresponding meanings is merely an example, as long as each meaning corresponds to a unique value. This is not limited in this application.

As shown in FIG. 5, the B-TWT element includes at least one of the following fields: an element ID, a length, control, and TWT parameter information. For example, quantities of bytes corresponding to the foregoing fields are respectively 1, 1, 1, and variable. Further, the control field may include at least one of the following fields:

a neighbor discovery protocol (NDP) paging record (NDP Paging Indicator), a responder PM mode, a negotiation type, TWT information frame disable, a wake duration unit, a link ID bitmap present field (Link ID Bitmap Present, or referred to as Link ID Present), and a reserved bit.

In some embodiments, a most significant bit of the negotiation type field is a broadcast field. For example, if the broadcast field is set to 1, it indicates that a type of a frame that carries the B-TWT element is a broadcast TWT frame, which will indicate a start time of a next B-TWT SP.

In some embodiments, if the TWT information frame disable field is set to 0, it indicates that a STA is allowed to receive a TWT information frame; if the TWT information frame disabled field is set to 1, it indicates that the STA is not allowed to receive a TWT information frame.

In some embodiments, the wake duration unit field represents a minimum time unit for setting TWT duration.

As an example, if the wake duration unit field is set to 0, it indicates that the minimum time unit is 256 us; if the wake duration unit field is set to 1, it indicates that the minimum time unit is TU.

In some embodiments, the link ID bitmap present field is used to indicate whether the B-TWT element includes a link ID bitmap field. For example, if a value of the link ID bitmap present field is 1, it indicates that the link ID bitmap field is included; otherwise, it indicates that the link ID bitmap field is not included.

Optionally, when the B-TWT element does not include the link ID bitmap field, it indicates that an application scenario of transmission herein is a single-link transmission scenario, or may correspond to a multi-link transmission scenario, for example, B-TWT parameter information of each link in the multi-link transmission scenario corresponds to one independent B-TWT element.

For example, when the B-TWT parameter information of each link corresponds to one B-TWT element, the B-TWT elements corresponding to the links may be arranged according to a sequence of values of link IDs, for example, in an ascending order or in a descending order.

As an example, there are three links between an AP MLD and a non-AP MLD: a link 1, a link 2, and a link 3. If the AP MLD schedules TWT SPs of the three links, and each link corresponds to independent TWT parameter information, a first frame may include three B-TWT elements, which are respectively used to carry TWT parameter information of the link 1, that of the link 2, and that of the link 3. In this case, link ID information may not be indicated in the B-TWT elements. The three B-TWT elements sequentially carry the TWT parameter information of the link 1, that of the link 2, and that of the link 3 in descending order or ascending order of link IDs.

Optionally, if the broadcast field in the control field is 1, the TWT parameter information field will carry B-TWT parameter information.

FIG. 6 is an exemplary diagram of a format of a TWT parameter information field in a B-TWT element according to an embodiment of this application.

It should be understood that a structure of the TWT parameter information field in FIG. 6, and a length and a location of each field included in the TWT parameter information field are merely examples. In actual application, the structure may be adjusted according to a specific requirement, which is not limited in this application.

It should also be understood that a relationship between values of the following fields and corresponding meanings is merely an example, as long as each meaning corresponds to a unique value. This is not limited in this application.

As shown in FIG. 6, the TWT parameter information field includes at least one of the following fields:

a request type field, a target wake time (TWT) field, a TWT wake interval mantissa field, a broadcast TWT information (Broadcast TWT Info) field, a restricted TWT traffic information (Restricted TWT Traffic Info) field (optional), and a link ID bitmap field. Further, the request type field includes at least one of the following fields:

a TWT request field, a TWT setup command field, a trigger field, a last broadcast parameter set field, a flow type field, a broadcast TWT recommendation, a TWT wake interval exponent, and a reserved bit.

In some embodiments, if the TWT request field in the request type field is set to 1, it indicates that a frame carrying the B-TWT element is a TWT request frame; if the TWT request field is set to 0, it indicates that a frame carrying the B-TWT element is a TWT response frame.

In some embodiments, if the trigger field in the request type field is set to 1, it indicates that a trigger frame is sent at least once before a TWT SP starts; if the trigger field is set to 0, it indicates that no trigger frame is sent. In other words, if the trigger field is set to 1, it indicates that a TWT SP is trigger-based; if the trigger field is set to 0, it indicates that a TWT SP is not trigger-based.

In some embodiments, if the last broadcast parameter set field is set to 1, it indicates that the B-TWT element is a last B-TWT element carried in a frame; if the last broadcast parameter set field is set to 0, it indicates that there is another B-TWT element subsequently.

In some embodiments, the flow type field represents a type of a frame exchanged between a TWT requester and a TWT responder.

For example, if the flow type field is set to 0, it indicates an announced TWT, and the TWT requester will send a PS-poll or an APSD trigger frame. If the flow type field is set to 1, it indicates an unannounced TWT, and the TWT responder transmits a frame to the TWT requester without waiting to receive a PS-poll or an APSD trigger frame from the TWT requester. If a TWT SP is trigger-based, the TWT responder expects the TWT requester to send a PS-poll or an APSD trigger frame.

In some embodiments, the broadcast TWT recommendation field indicates a recommendation of an AP MLD on a type of a frame transmitted within a B-TWT SP.

For example, if the broadcast TWT recommendation field is set to 0, it indicates that the AP MLD has no limitation on the type of the frame transmitted during the B-TWT SP. If the broadcast TWT recommendation field is set to 1, it indicates that a transmission request or a requested feedback does not include a randomly accessed resource unit (RU). If the broadcast TWT recommendation field is set to 2, it indicates that the transmission request or the requested feedback includes at least one randomly accessed RU. If the broadcast TWT recommendation field is set to 3, it indicates that there is no limitation except for a traffic indication map (TIM) frame or a fast initial link setup (FILS) discovery frame including a TIM element that is sent by an AP.

In some embodiments, the TWT field is used to indicate a start time of a TWT SP scheduled by the AP MLD.

It should be understood that the broadcast TWT info field is valid when the broadcast field in the negotiation type field is 1.

Optionally, when the first bit of the broadcast TWT info field is a restricted TWT traffic info present field, and the restricted TWT traffic info present field is 1, it indicates that the restricted TWT traffic info field exists in the B-TWT element. Otherwise, the restricted TWT traffic info present field is set to 0.

It should be understood that in this embodiment of this application, target links indicated by a link ID bitmap field in a same B-TWT element share B-TWT parameter information carried in the B-TWT element. For example, a start time of a B-TWT SP, whether a trigger frame needs to be sent, whether a STA responds to a PS-poll or an APSD frame within duration of a TWT SP, and a type of a frame recommended by the AP MLD for sending within duration of the B-TWT SP.

Optionally, if TWT parameter information that needs to be set for at least two links is different, a plurality of B-TWT elements may be carried in a first frame, and each B-TWT carries different B-TWT parameter information to indicate B-TWT SP parameter settings on different links.

Optionally, a non-AP MLD may determine, according to the last broadcast parameter set field in the TWT parameter information field, whether a current B-TWT element is a last B-TWT element. For example, if the last broadcast parameter set field is set to 1, it indicates that the current B-TWT element is the last B-TWT element; otherwise, it indicates that there is another B-TWT element subsequently.

When the AP MLD uses the R-TWT element to carry the R-TWT parameter information, an implementation is similar, and details are not described herein again. For example, if the AP MLD sets that all links correspond to same R-TWT parameter information, the first frame may include one R-TWT element; or if the AP MLD sets that each link corresponds to its own R-TWT parameter information, the first frame may include a plurality of R-TWT elements, which respectively indicate R-TWT parameter information of corresponding links.

In some embodiments, when a broadcast TWT recommendation field in a B-TWT element is equal to 4, the B-TWT element is referred to as an R-TWT element.

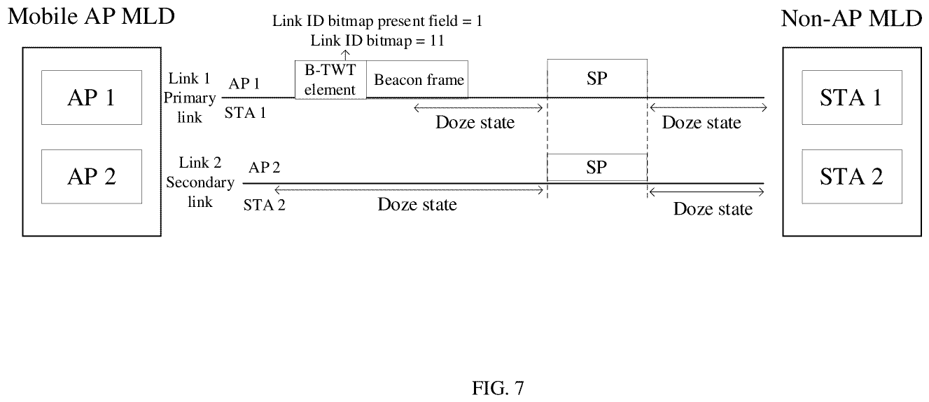

With reference to FIG. 7, a multi-link TWT operation method based on a mobile AP MLD is described by using an example.

As shown in FIG. 7, there are two links between a mobile AP MLD and a non-AP MLD. A link 1 (Link1) is a primary link, and a link 2 (Link2) is a secondary link. The mobile AP MLD includes an AP 1 and an AP 2. The non-AP MLD includes a STA 1 and a STA 2. The AP 1 and the STA I work on the link 1, and the AP 2 and the STA 2 work on the link 2.

Due to an NSTR feature, the mobile AP MLD does not support simultaneous transmission and reception of two links. Therefore, the AP 1 in the mobile AP MLD may send a beacon frame that carries a B-TWT element on the primary link, and indicate, by using a link ID bitmap field in the B-TWT element, a link on which the mobile AP MLD sets a TWT SP. Then, the mobile AP MLD enters a doze state. For example, as shown in FIG. 7, if the mobile AP MLD sets a TWT SP of the link 1 and that of the link 2, the link ID bitmap field is set to 11, indicating that the mobile AP MLD schedules the TWT SP of the link 1 and that of the link 2.

After receiving the beacon frame, the STA 1 in the non-AP STA learns the TWT SP of the link 1 and that of the link 2. In this case, the STA 1 and the STA 2 in the non-AP STA wake up after a B-TWT SP indicated in the B-TWT element starts, and the AP 1 and the AP 2 in the mobile AP MLD also wake up after the B-TWT SP starts, and exchange frames with STAs in the non-AP STA that are on corresponding links. After the B-TWT SP ends, the mobile AP MLD and the non-AP MLD enter the doze state. A current round of B-TWT SP scheduling ends.

In some other cases, the mobile AP MLD may send a beacon frame that carries an R-TWT element on the primary link, and indicate, by using a link ID bitmap field in the R-TWT element, a link on which an R-TWT SP is set. For example, if the mobile AP MLD sets a TWT SP of the link 1 and that of the link 2, the link ID bitmap field is set to 11, indicating that the mobile AP MLD schedules the TWT SP of the link 1 and that of the link 2.

After the non-AP STA receives the beacon frame, the STA 1 and the STA 2 in the non-AP STA wake up after an R-TWT SP indicated in the R-TWT element starts, and the AP 1 and the AP 2 in the mobile AP MLD also wake up after the R-TWT SP starts, and exchange frames with STAs in the non-AP STA that are on corresponding links. It should be understood that the frame interaction herein meets an operation rule of restricted TWT on each link and an operation rule between the primary link and the secondary link of the mobile AP MLD.

The primary-secondary link pair of the mobile AP MLD has an NSTR feature, and an AP or a STA on the secondary link cannot separately access a channel to obtain a TXOP, but can only perform transmission by using a TXOP obtained by an AP or a STA on the primary link. Therefore, the AP of the mobile AP MLD that is on the secondary link does not have a capability of separately scheduling the B-TWT SP.

Based on the foregoing reasons, in this embodiment of this application, when setting the TWT SP on the primary link and that on the secondary link, the mobile AP MLD needs to follow a specific rule. For example, the TWT SP of the primary link set by the mobile AP MLD needs to completely cover the TWT SP of the secondary link.

For example, the mobile AP MLD may set the TWT SP of the primary link and that of the secondary link based on the following rules.

It should be understood that the following example rules may be applied to the mobile AP MLD, and may also be applied to another AP MLD that has an NSTR feature. This is not limited in this application.

Rule 1: A start time of the TWT SP of the primary link is aligned with a start time of the TWT SP of the secondary link.

That is, the TWT SP scheduled by the mobile AP MLD on the primary link is required to be synchronized with that on the secondary link.

For example, during a TWT SP, the mobile AP MLD or the non-AP MLD follows a rule of start time alignment when performing PPDU transmission on the primary link and the secondary link.

For the rule 1, within the TWT SP, when an AP affiliated with the mobile AP MLD and a no-AP STA of the non-AP MLD are to perform transmission on the secondary link, a channel access rule of PPDU start time synchronization is required.

That is, when an AP of the mobile AP MLD that is on the primary link and a non-AP STA of the non-AP MLD that is on the primary link initiate PPDU transmission as TXOP holders, an AP and a non-AP STA on the secondary link can transmit a PPDU at a start time of the same TXOP. Therefore, the TWT SP scheduled on the primary link is required to be synchronized with that on the secondary link, and the PPDU transmission needs to follow the rule of start time alignment.

Based on the rule 1, in some embodiments, when setting the TWT SP of the primary link and that of the secondary link, the mobile AP MLD may set that the primary link and the secondary link correspond to same TWT parameter information. For example, a beacon frame sent by the AP of the mobile AP MLD that is on the primary link includes one B-TWT element or one R-TWT element. It is set, by using a link ID bitmap field, that the TWT SP on the primary link and that on the secondary link are both determined according to TWT parameter information indicated in the B-TWT element or the R-TWT element.

Rule 2: The start time of the TWT SP of the secondary link is not earlier than the start time of the TWT SP of the primary link.

Rule 3: An end time of the TWT SP of the secondary link is not later than an end time of the TWT SP of the primary link.

That is, the TWT SP scheduled by the mobile AP MLD on the primary link and that on the secondary link may be synchronized or may not be synchronized. For example, the start time of the TWT SP scheduled on the secondary link is not earlier than the start time of the TWT SP scheduled on the primary link, and/or, the end time of the TWT SP scheduled on the secondary link is not later than the end time of the TWT SP scheduled on the primary link.

In conclusion, the start time of the TWT SP scheduled on the secondary link may be the same as the start time of the TWT SP scheduled on the primary link or the start time of the TWT SP scheduled on the secondary link may be later than the start time of the TWT SP scheduled on the primary link, or the end time of the TWT SP scheduled on the secondary link may be the same as the end time of the TWT SP scheduled on the primary link, or the end time of the TWT SP scheduled on the secondary link may be earlier than the end time of the TWT SP scheduled on the primary link.

Optionally, when the mobile AP MLD sets that the primary link and the secondary link correspond to a same TWT SP, a first frame sent by the mobile AP MLD includes one B-TWT element or one R-TWT element, and both the TWT SP on the primary link and that on the secondary link are determined according to TWT parameter information indicated in the B-TWT element or the R-TWT element. Alternatively, when the mobile AP MLD sets that the primary link and the secondary link correspond to different TWT SPs, the first frame sent by the mobile AP MLD includes a plurality of B-TWT elements or R-TWT elements, which are respectively used to carry corresponding TWT parameter information.

Rule 4: The mobile AP MLD sets at least the TWT SP corresponding to the primary link.

That is, the mobile AP MLD may not set (or schedule) the TWT SP corresponding to the secondary link. However, if the TWT SP corresponding to the secondary link is set (or scheduled), the TWT SP corresponding to the primary link must be set (or scheduled) at the same time.

In other words, first information includes at least TWT parameter information corresponding to the primary link. For example, the first information includes only the TWT parameter information corresponding to the primary link, or may include the TWT parameter information corresponding to the primary link and TWT parameter information corresponding to the secondary link.

In some embodiments, when using the multi-link TWT operation method in this embodiment of this application, the mobile AP MLD selects, according to an actual situation, whether to schedule the TWT SP of the secondary link. That is, the mobile AP MLD may not perform TWT SP setting on the secondary link, that is, the secondary link may not correspond to TWT parameter information.

The following describes the foregoing rules 1 to 4 with reference to specific examples.

Case 1: The start time of the TWT SP of the primary link is aligned with the start time of the TWT SP of the secondary link, and the end time of the TWT SP of the primary link is aligned with the end time of the TWT SP of the secondary link.

As an example, as shown in FIG. 7, the mobile AP MLD may set that the primary link and the secondary link correspond to a same TWT SP. For example, if a link ID present field in a B-TWT element carried in a beacon frame is set to 1, it indicates that TWT parameter information in the B-TWT element is applied to B-TWT scheduling of a plurality of links, and a link ID bitmap being equal to 11 indicates that the TWT parameter information in the B-TWT element is applied to the link 1 and the link 2. In this case, the TWT SP on the primary link completely overlaps that on the secondary link. That is, the start time of the TWT SP on the link 1 is the same as that of the link 2, and the link 1 and the link 2 enter a doze state at the same time after transmission ends.

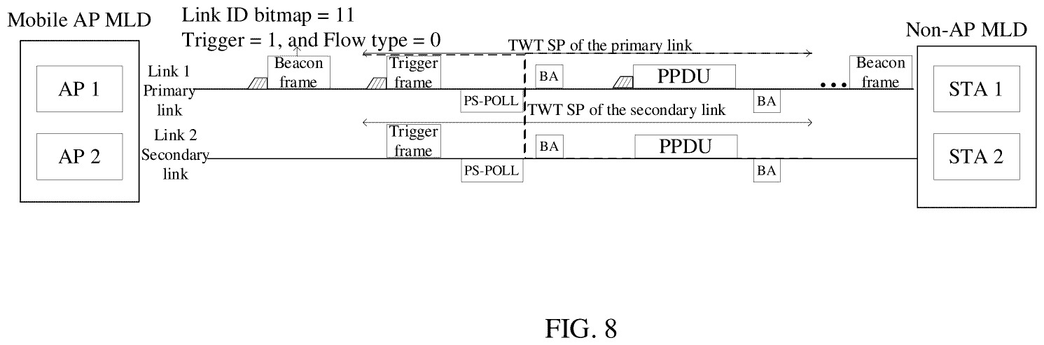

As another example, as shown in FIG. 8, there are two links between a mobile AP MLD and a non-AP MLD. A link 1 (Link1) is a primary link, and a link 2 (Link2) is a secondary link. The mobile AP MLD includes an AP 1 and an AP 2, and the non-AP MLD includes a STA 1 and a STA 2. The AP 1 and the STA I work on the link 1, and the AP 2 and the STA 2 work on the link 2.

The mobile AP MLD sets that the primary link and the secondary link correspond to a same TWT SP. For example, if a link ID bitmap in a B-TWT element carried in a beacon frame is set to 11, it indicates that TWT parameter information in the B-TWT element is applied to the link 1 and the link 2. If a value of a trigger field is 1, and a value of a flow type field is 0, it indicates that a scheduling type of the TWT SP on the primary link and that on the secondary link is a triggered-enabled TWT SP and an announced TWT SP. In this case, the TWT SP on the primary link completely overlaps that on the secondary link. That is, a start time of the TWT SP on the link 1 is the same as that of the link 2, and the link 1 and the link 2 enter a doze state at the same time after transmission ends.

Specifically, starting from a start location of the scheduled TWT SP, the AP 1 affiliated with the mobile AP MLD performs backoff-channel contention on the primary link to obtain a first TXOP, and then the AP 1 and the AP 2 send, based on the first TXOP, trigger frames to the STA 1 and the STA 2 affiliated with the non-AP MLD on the primary link and the secondary link. After the STA 1 and the STA 2 receive the trigger frames, the STA 1 and the STA 2 send PS-poll frames on the corresponding links to request downlink data transmission. After the AP 1 and the AP 2 receive the PS-poll frames sent by the STAs on the corresponding links, the AP 1 and the AP 2 reply with block ACK frames. After the first TXOP ends, if the affiliated APs of the mobile AP MLD still have temporarily stored data that needs to be sent, the AP 1 contends for another TXOP on the primary link to perform PPDU transmission.

Case 2: The start time of the TWT SP of the primary link is not aligned with the start time of the TWT SP of the secondary link, and an end time of the TWT SP of the primary link is aligned with an end time of the TWT SP of the secondary link.

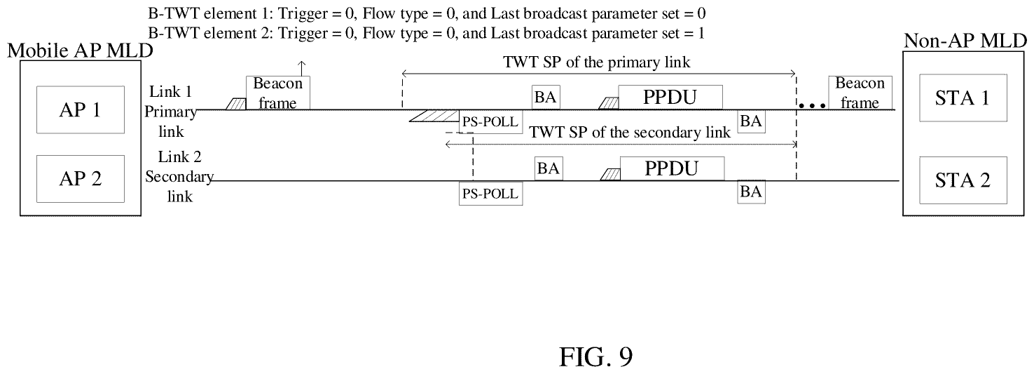

For another example, as shown in FIG. 9, there are two links between a mobile AP MLD and a non-AP MLD. A link 1 (Link1) is a primary link, and a link 2 (Link2) is a secondary link. The mobile AP MLD includes an AP 1 and an AP 2, and the non-AP MLD includes a STA 1 and a STA 2. The AP 1 and the STA I work on the link 1, and the AP 2 and the STA 2 work on the link 2.

The mobile AP MLD may set that the primary link and the secondary link correspond to different TWT SPs. For example, it is set that a beacon frame carries a B-TWT element 1 and a B-TWT element 2, which respectively correspond to the link 1 and the link 2. A TWT field of the B-TWT element 1 is different from that of the B-TWT element 2. Specifically, a start time indicated by the TWT field in the B-TWT element 2 is later than a start time indicated by the TWT field in the B-TWT element 1.

In the B-TWT element 1, if a last broadcast parameter set field is equal to 0, it indicates that there is a B-TWT element subsequently.

A trigger field and a flow type field in the B-TWT element 1 and those in the B-TWT element 2 are all 0, indicating that a trigger frame is not sent but only a PS-poll frame is sent during transmission on the primary link and the secondary link.

Specifically, as shown in FIG. 9, starting from a start location of a scheduled TWT SP, the AP 1 affiliated with the mobile AP MLD performs backoff-channel contention on the primary link. In this process, the STA 2 and the AP 2 on the secondary link wake up. After the AP 1 obtains a channel and a second TXOP through contention, the STAs on the primary link and the secondary link simultaneously use the second TXOP to send PS-poll frames to request downlink data. The AP 1 and the AP 2 reply with BA frames after receiving the PS-poll frames sent by the STAs on the corresponding links. After the second TXOP ends, if the affiliated APs of the mobile AP MLD still have temporarily stored data that needs to be sent, the AP 1 contends for another TXOP on the primary link to perform PPDU transmission.

Case 3: The start time of the TWT SP of the primary link is aligned with the start time of the TWT SP of the secondary link, and the end time of the TWT SP of the primary link is not aligned with the end time of the TWT SP of the secondary link.

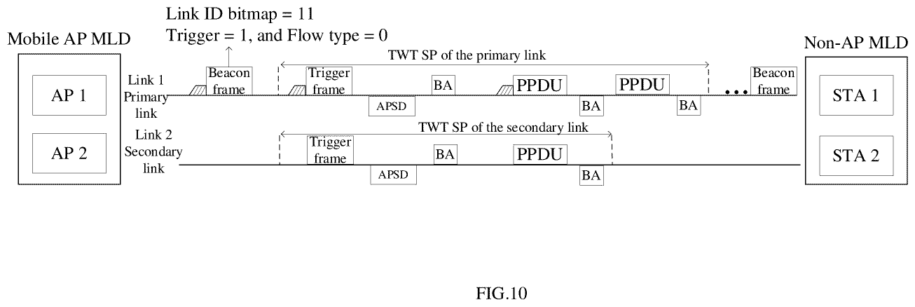

As an example, as shown in FIG. 10, there are two links between a mobile AP MLD and a non-AP MLD. A link 1 (Link1) is a primary link, and a link 2 (Link2) is a secondary link. The mobile AP MLD includes an AP 1 and an AP 2, and the non-AP MLD includes a STA 1 and a STA 2. The AP 1 and the STA I work on the link 1, and the AP 2 and the STA 2 work on the link 2.

The mobile AP MLD may set that the primary link and the secondary link correspond to a same TWT SP. For example, if a link ID bitmap in a B-TWT element carried in a beacon frame is set to 11, it indicates that TWT parameter information in the B-TWT element is applied to the link 1 and the link 2. If a value of a trigger field is 1, and a value of a flow type field is 0, it indicates that a scheduling type of the TWT SP on the primary link and that on the secondary link is a triggered-enabled TWT SP and an announced TWT SP. In this case, a start time of the TWT SP on the link 1 is the same as that of the link 2.

Specifically, as shown in FIG. 10, starting from a start location of the scheduled TWT SP, the AP 1 affiliated with the mobile AP MLD performs backoff-channel contention on the primary link to obtain a third TXOP, and then the AP 1 and the AP 2 send, based on the third TXOP, trigger frames to the STA 1 and the STA 2 affiliated with the non-AP MLD on the primary link and the secondary link. After the STA 1 and the STA 2 receive the trigger frames, the STA 1 and the STA 2 send APSD frames on the corresponding links to request downlink data transmission. After the AP 1 and the AP 2 receive the APSD frames sent by the STAs on the corresponding links, the AP 1 and the AP 2 reply with BA frames. Because a quantity of PPDUs temporarily stored by the AP 1 on the primary link is more than a quantity of PPDUs temporarily stored by the AP 2 on the secondary link, the AP 2 of the secondary link may actively end a current B-TWT SP after one PPDU is transmitted and a BA frame is received. In this way, the end time of the TWT SP of the primary link is later than the end time of the TWT SP of the secondary link.

Case 4: The start time of the TWT SP of the primary link is not aligned with the start time of the TWT SP of the secondary link, and the end time of the TWT SP of the primary link is not aligned with the end time of the TWT SP of the secondary link.

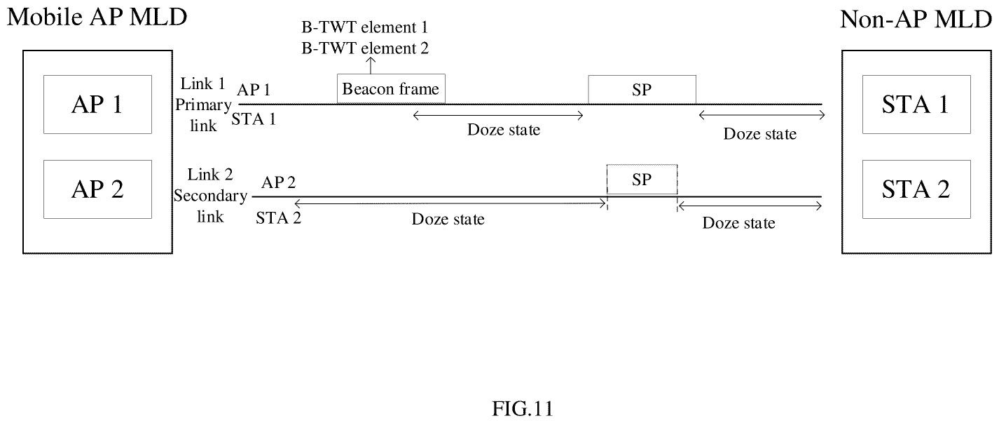

For example, as shown in FIG. 11, there are two links between a mobile AP MLD and a non-AP MLD. A link 1 (Link1) is a primary link, and a link 2 (Link2) is a secondary link. The mobile AP MLD includes an AP 1 and an AP 2, and the non-AP MLD includes a STA 1 and a STA 2. The AP 1 and the STA I work on the link 1, and the AP 2 and the STA 2 work on the link 2.

The mobile AP MLD needs to set that the primary link and the secondary link correspond to different TWT SPs, for example, set a B-TWT element 1 and a B-TWT element 2 carried in a beacon frame. By setting values of TWT parameter fields in the B-TWT element 1 and the B-TWT element 2, a start time of a TWT SP on the primary link is earlier than a start time of a TWT SP on the secondary link, and an end time of the TWT SP on the primary link is later than an end time of the TWT SP on the secondary link.

In some embodiments, the mobile AP MLD may determine, according to channel busy status of the secondary link and an amount of temporarily stored downlink data, whether the start time of the B-TWT SP of the secondary link is aligned with the start time of the TWT SP of the primary link and/or whether the end time of the B-TWT SP of the secondary link is aligned with the end time of the TWT SP of the primary link. For example, in a case in which the amount of temporarily stored downlink data is relatively small, the mobile AP MLD may set that the end time of the TWT SP scheduled on the secondary link is earlier than the end time of the TWT SP scheduled on the primary link.

Case 5: Only the TWT SP of the primary link is set, and the TWT SP of the secondary link is not set.

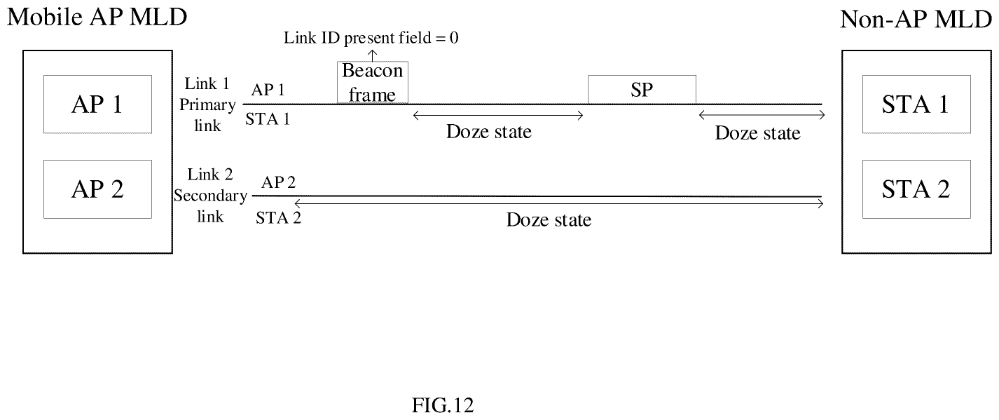

For example, as shown in FIG. 12, there are two links between a mobile AP MLD and a non-AP MLD. A link 1 (Link1) is a primary link, and a link 2 (Link2) is a secondary link. The mobile AP MLD includes an AP 1 and an AP 2, and the non-AP MLD includes a STA 1 and a STA 2. The AP 1 and the STA I work on the link 1, and the AP 2 and the STA 2 work on the link 2.

If the mobile AP MLD sets only a TWT SP of the primary link, the AP 1 in the mobile AP MLD may send a beacon frame on the link 1. If a link ID present field in a B-TWT element in the beacon frame is set to 0, it indicates that a link ID bitmap field does not exist, or a plurality of links are not enabled, or an application scenario of current transmission is broadcast TWT in a single-link scenario. In this case, B-TWT parameter information indicated in the B-TWT element is only applied on the link 1 on which the beacon frame is sent. The AP 1 and the STA 1 on the link 1 determine a B-TWT SP according to the B-TWT element, wake up after the B-TWT SP starts, and perform data transmission, while the AP 2 and the STA 2 on the link 2 remain in a doze state.

In some embodiments of this application, the first frame sent by the first AP on the first link further includes a first quiet element, and the first quiet element is used to indicate information about a quiet interval Quiet Interval corresponding to the TWT SP of the first link. For example, the first quiet element is used to determine a time location of the quiet interval corresponding to the TWT SP of the first link.

In some embodiments, the second non-AP STA receives a second frame on the second link, where the second frame includes a second quiet element, and the second quiet element is used to indicate information about a quiet interval corresponding to a TWT SP of the second link. For example, the second quiet element is used to determine a time location of the quiet interval corresponding to the TWT SP of the second link.

Optionally, the second frame is a broadcast frame, for example, a functional frame that does not need to be acknowledged, for example, an action frame.

In some embodiments, duration of the quiet interval on the second link covers duration of the TWT SP on the second link.

For example, a start time of the quiet interval on the second link is the same as a start time of the TWT SP corresponding to the second link.

For another example, the start time of the quiet interval on the second link is not later than the start time of the TWT SP corresponding to the second link.

For another example, an end time of the quiet interval on the second link is the same as an end time of the TWT SP corresponding to the second link.

For another example, the end time of the quiet interval on the second link is not earlier than the end time of the TWT SP corresponding to the second link.

In some embodiments, duration of the quiet interval on the first link covers duration of the TWT SP on the first link.

For example, a start time of the quiet interval on the first link is the same as a start time of the TWT SP corresponding to the first link.

For another example, the start time of the quiet interval on the first link is not later than the start time of the TWT SP corresponding to the first link.

For another example, an end time of the quiet interval on the first link is the same as an end time of the TWT SP corresponding to the first link.

For another example, the end time of the quiet interval on the first link is not earlier than the end time of the TWT SP corresponding to the first link.

In some embodiments, the start time of the quiet interval on the first link is the same as the start time of the quiet interval on the second link.

In some embodiments, the start time of the quiet interval on the first link is the same as the start time of the TWT SP corresponding to the first link.

An example in which the first AP uses an R-TWT element to carry first information on the first link is used to describe a multi-link TWT operation method based on R-TWT. When a broadcast TWT recommendation field in a B-TWT element is equal to 4, the B-TWT element is referred to as an R-TWT element.

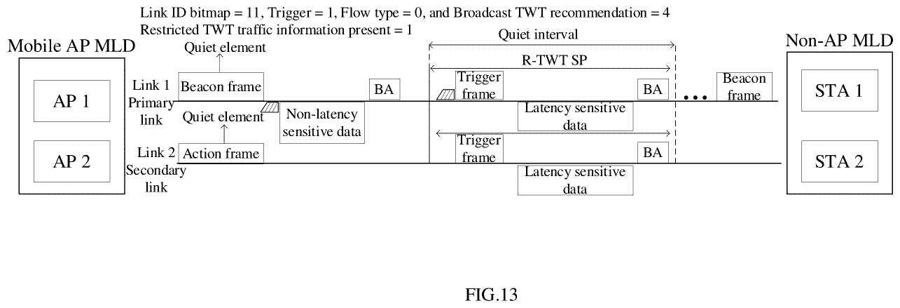

As shown in FIG. 13, there are two links between a mobile AP MLD and a non-AP MLD. A link 1 (Link1) is a primary link, and a link 2 (Link2) is a secondary link. The mobile AP MLD includes an AP 1 and an AP 2. The non-AP MLD includes a STA 1 and a STA 2. The AP 1 and the STA I work on the link 1, and the AP 2 and the STA 2 work on the link 2.

The AP 1 adds one R-TWT element and one quiet element in a beacon frame, where the R-TWT element indicates a start time of the primary link and that of the secondary link, the quiet element indicates a start time of a quiet interval, and the quiet interval is set to protect channel access of a STA within an R-TWT SP. As limited by a transmission rule of the mobile AP MLD, the secondary link cannot transmit the beacon frame. Therefore, the AP 2 may use an action frame that does not need to be acknowledged to carry the quiet element on the secondary link.

A start time of an R-TWT SP of the primary link indicated by an R-TWT element is the same as that of the secondary link, a start time of a quiet interval of the primary link indicated by a quiet element is the same as that of the secondary link, and a start time of an R-TWT SP of the primary link and the secondary link is the same as a start time of a quiet interval of the primary link and the secondary link.

Therefore, transmission of non-latency sensitive (non-LS) data (that is, data that has a non-LS communication identifier (TID)) needs to end before a quiet interval. After an R-TWT SP starts, latency sensitive (LS) data (that is, data that has an LS TID) can only be transmitted by a STA. Therefore, an affiliated AP in the mobile AP MLD only needs to send a trigger frame to instruct a STA on a corresponding link to perform uplink transmission, without requiring a PS-poll or an APSD frame. After the transmission of the latency sensitive data is completed, a current round of R-TWT SP scheduling ends.

In conclusion, in this embodiment of this application, an affiliated AP of the AP MLD may send first information to an affiliated STA of the non-AP MLD on one link, and the first information includes TWT parameter information corresponding to at least one link. Therefore, the non-AP MLD may determine a TWT SP of the at least one link according to the TWT parameter information, thereby facilitating power-saving management in a multi-link scenario.

In some embodiments, an affiliated AP in an NSTR AP MLD that is on a primary link may send TWT parameter information corresponding to the primary link and a secondary link to an affiliated STA of a non-AP MLD, so that power-saving management of the secondary link can be implemented by using the primary link.

In some embodiments, an affiliated AP in the AP MLD may use a B-TWT element or an R-TWT element to carry TWT parameter information of at least one link.

In some embodiments, the AP MLD may indicate, in a bitmap manner, a target link to which the TWT parameter information carried in the B-TWT element or the R-TWT element is applied. This meets power-saving management in a multi-link transmission scenario.

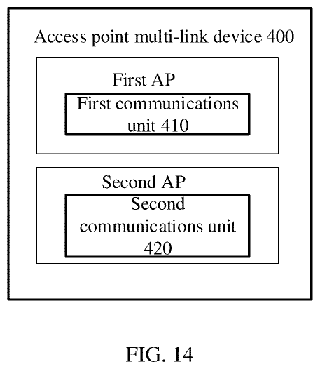

The foregoing describes method embodiments of this application in detail with reference to FIG. 4 to FIG. 13. The following describes apparatus embodiments of this application in detail with reference to FIG. 14 to FIG. 18. It should be understood that the apparatus embodiments are corresponding to the method embodiments. For similar descriptions, refer to the method embodiments.

FIG. 14 is a schematic block diagram of an access point multi-link device AP MLD 400 according to an embodiment of this application. As shown in FIG. 14, the AP MLD 400 includes at least a first AP and a second AP that are affiliated with the AP MLD 400, the first AP works on a first link, the second AP works on a second link, and the first AP includes:

a first communications unit 410, configured to send, on the first link, first information to a non-access point non-AP MLD device, where the first information includes at least one piece of target wake time TWT parameter information, and the TWT parameter information is used to determine a TWT SP, where the at least one piece of TWT parameter information is broadcast TWT B-TWT parameter information or restricted TWT R-TWT parameter information, and the at least one piece of TWT parameter information corresponds to at least one link.

In some embodiments, the first information further includes first indication information, and the first indication information is used to indicate a target link corresponding to the at least one piece of TWT parameter information.

In some embodiments, the first indication information indicates, in a bitmap manner, the target link corresponding to the at least one piece of TWT parameter information.

In some embodiments, the first indication information includes a first bitmap, the first information includes first TWT parameter information, the first bitmap corresponds to the first TWT parameter information, the first bitmap includes a plurality of bits, each bit corresponds to a link ID, and a value of each bit is used to indicate whether the first TWT parameter information is applied to a link indicated by a corresponding link ID.

In some embodiments, the at least one link corresponds to same TWT parameter information; or

the at least one link respectively corresponds to independent TWT parameter information.

In some embodiments, the AP MLD device includes a mobile Mobile AP MLD device.

In some embodiments, the first link is a primary link.

In some embodiments, the at least one link includes the first link and the second link, the first link is a primary link, and the second link is a secondary link.

In some embodiments, duration of a TWT SP corresponding to a primary link covers duration of a TWT SP corresponding to a secondary link.

In some embodiments, a start time of a TWT SP corresponding to a secondary link is the same as a start time of a TWT SP corresponding to a primary link.

In some embodiments, a start time of a TWT SP corresponding to a secondary link is not earlier than a start time of a TWT SP corresponding to a primary link.

In some embodiments, an end time of a TWT SP corresponding to a secondary link is not later than an end time of a TWT SP corresponding to a primary link.

In some embodiments, the at least one piece of TWT parameter information includes TWT parameter information of a primary link; or

the at least one piece of TWT parameter information includes TWT parameter information of a primary link and TWT parameter information of at least one secondary link.

In some embodiments, the first information is carried in a B-TWT element or an R-TWT element in a first frame.

In some embodiments, the first frame includes one or more B-TWT elements, and the B-TWT element is used to carry the B-TWT parameter information; or

the first frame includes one or more R-TWT elements, and the R-TWT element is used to carry the R-TWT parameter information.

In some embodiments, the B-TWT element includes a TWT parameter information field, and the TWT parameter information field is used to carry the B-TWT parameter information; or

the R-TWT element includes a TWT parameter information field, and the TWT parameter information field is used to carry the R-TWT parameter information.

In some embodiments, the R-TWT element further includes a link ID bitmap field, and the link ID bitmap field is used to indicate a target link to which the B-TWT parameter information indicated by the TWT parameter information field in the B-TWT element is applied; or

the R-TWT element further includes a link ID bitmap field, and the link ID bitmap field is used to indicate a target link to which the R-TWT parameter information indicated by the TWT parameter information field in the R-TWT element is applied.

In some embodiments, the B-TWT element further includes a control field, the control field includes a link ID bitmap present field, and the link ID bitmap present field is used to indicate whether the B-TWT element includes the link ID bitmap field; or

the R-TWT element further includes a control field, the control field includes a link ID bitmap present field, and the link ID bitmap present field is used to indicate whether the R-TWT element includes the link ID bitmap field.

In some embodiments, the first frame includes at least one of the following frames: a beacon frame and a management frame.

In some embodiments, the first frame further includes a first quiet element Quiet element, and the first quiet element is used to indicate information about a quiet interval Quiet Interval corresponding to a TWT SP of the first link.

In some embodiments, the first frame includes at least one R-TWT element, and the R-TWT element is used to carry the R-TWT parameter information.

In some embodiments, the second AP includes:

a second communications unit 420, configured to send a second frame on the second link, where the second frame includes a second quiet element, and the second quiet element is used to indicate information about a quiet interval corresponding to a TWT SP of the second link.

In some embodiments, duration of the quiet interval on the second link covers duration of the TWT SP on the second link.

In some embodiments, duration of the quiet interval on the first link covers duration of the TWT SP on the first link.

In some embodiments, the second frame is a broadcast frame.

In some embodiments, the foregoing communications unit may be a communications interface or a transceiver, or an input/output interface of a communications chip or a system on a chip.

It should be understood that the access point multi-link device 400 according to this embodiment of this application may correspond to an AP MLD in the method embodiments of this application, and the foregoing and other operations and/or functions of units in the access point multi-link device 400 are respectively used to implement corresponding procedures of the AP MLD in the method 200 shown in FIG. 4. For brevity, details are not described herein again.

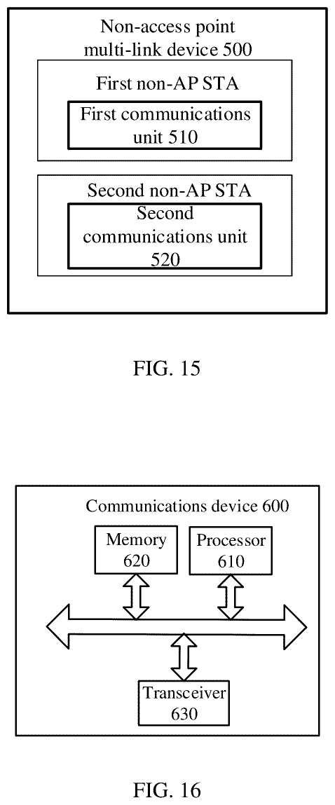

FIG. 15 is a schematic block diagram of a non-access point multi-link device Non-AP MLD according to an embodiment of this application. The non-AP MLD 500 in FIG. 15 includes at least a first non-AP STA and a second non-AP STA that are affiliated with the non-AP MLD 500, the first non-AP STA works on a first link, and the second non-AP STA works on a second link. The first non-AP STA includes:

a first communications unit 510, configured to receive, on the first link, first information sent by an access point AP MLD device, where the first information includes at least one piece of target wake time TWT parameter information, and the TWT parameter information is used to determine a TWT SP, where the at least one piece of TWT parameter information is broadcast TWT B-TWT parameter information or restricted TWT R-TWT parameter information, and the at least one piece of TWT parameter information corresponds to at least one link.

In some embodiments, the first information further includes first indication information, and the first indication information is used to indicate a target link corresponding to the at least one piece of TWT parameter information.

In some embodiments, the first indication information indicates, in a bitmap manner, the target link corresponding to the at least one piece of TWT parameter information.

In some embodiments, the first indication information includes a first bitmap, the first information includes first TWT parameter information, the first bitmap corresponds to the first TWT parameter information, the first bitmap includes a plurality of bits, each bit corresponds to a link ID, and a value of each bit is used to indicate whether the first TWT parameter information is applied to a link indicated by a corresponding link ID.

In some embodiments, the at least one link corresponds to same TWT parameter information; or

the at least one link respectively corresponds to independent TWT parameter information.

In some embodiments, the AP MLD device includes a mobile Mobile AP MLD device.

In some embodiments, the first link is a primary link.

In some embodiments, the at least one link includes the first link and the second link, the first link is a primary link, and the second link is a secondary link.

In some embodiments, duration of a TWT SP corresponding to a primary link covers duration of a TWT SP corresponding to a secondary link.

In some embodiments, a start time of a TWT SP corresponding to a secondary link is the same as a start time of a TWT SP corresponding to a primary link.

In some embodiments, a start time of a TWT SP corresponding to a secondary link is not earlier than a start time of a TWT SP corresponding to a primary link.

In some embodiments, an end time of a TWT SP corresponding to a secondary link is not later than an end time of a TWT SP corresponding to a primary link.

In some embodiments, the at least one piece of TWT parameter information includes TWT parameter information of a primary link; or

the at least one piece of TWT parameter information includes TWT parameter information of a primary link and TWT parameter information of at least one secondary link.

In some embodiments, the first information is carried in a B-TWT element or an R-TWT element in a first frame.

In some embodiments, the first frame includes one or more B-TWT elements, and the B-TWT element is used to carry the B-TWT parameter information; or

the first frame includes one or more R-TWT elements, and the R-TWT element is used to carry the R-TWT parameter information.

In some embodiments, the B-TWT element includes a TWT parameter information field, and the TWT parameter information field is used to carry the B-TWT parameter information; or

the R-TWT element includes a TWT parameter information field, and the TWT parameter information field is used to carry the R-TWT parameter information.

In some embodiments, the R-TWT element further includes a link ID bitmap field, and the link ID bitmap field is used to indicate a target link to which the B-TWT parameter information indicated by the TWT parameter information field in the B-TWT element is applied; or

the R-TWT element further includes a link ID bitmap field, and the link ID bitmap field is used to indicate a target link to which the R-TWT parameter information indicated by the TWT parameter information field in the R-TWT element is applied.

In some embodiments, the B-TWT element further includes a control field, the control field includes a link ID bitmap present field, and the link ID bitmap present field is used to indicate whether the B-TWT element includes the link ID bitmap field; or

the R-TWT element further includes a control field, the control field includes a link ID bitmap present field, and the link ID bitmap present field is used to indicate whether the R-TWT element includes the link ID bitmap field.

In some embodiments, the first frame includes at least one of the following frames: a beacon frame and a management frame.

In some embodiments, the first frame further includes a first quiet element Quiet element, and the first quiet element is used to indicate information about a quiet interval Quiet Interval corresponding to a TWT SP of the first link.

In some embodiments, the first frame includes at least one R-TWT element, and the R-TWT element is used to carry the R-TWT parameter information.

In some embodiments, the second non-AP STA includes:

a second communications unit 520, configured to receive a second frame on the second link, where the second frame includes a second quiet element, and the second quiet element is used to indicate information about a quiet interval corresponding to a TWT SP of the second link.

In some embodiments, duration of the quiet interval on the second link covers duration of the TWT SP on the second link.

In some embodiments, duration of the quiet interval on the first link covers duration of the TWT SP on the first link.

In some embodiments, the second frame is a broadcast frame.

In some embodiments, the foregoing communications unit may be a communications interface or a transceiver, or an input/output interface of a communications chip or a system on a chip. The processing unit may be one or more processors.

It should be understood that the non-access point multi-link device according to this embodiment of this application may correspond to a non-AP MLD in the method embodiments of this application, and the foregoing and other operations and/or functions of units in the non-access point multi-link device 500 are respectively used to implement corresponding procedures of the non-access point multi-link device in the method 200 shown in FIG. 4. For brevity, details are not described herein again.

FIG. 16 is a schematic structural diagram of a communications device 600 according to an embodiment of this application. The communications device 600 shown in FIG. 16 includes a processor 610, and the processor 610 may invoke a computer program from a memory and run the computer program to implement a method in embodiments of this application.

Optionally, as shown in FIG. 16, the communications device 600 may further include a memory 620. The processor 610 may invoke a computer program from the memory 620 and run the computer program to implement a method in embodiments of this application.

The memory 620 may be a separate component independent of the processor 610, or may be integrated into the processor 610.

Optionally, as shown in FIG. 16, the communications device 600 may further include a transceiver 630. The processor 610 may control the transceiver 630 to communicate with another device, and specifically, may send information or data to the another device, or receive information or data sent by the another device.

The transceiver 630 may include a transmitter and a receiver. The transceiver 630 may further include an antenna, and a quantity of the antenna may be one or more.

Optionally, the communications device 600 may specifically be an AP MLD in embodiments of this application, and the communications device 600 may implement corresponding procedures implemented by the AP MLD in the methods according to embodiments of this application. For brevity, details are not described herein again.

Optionally, the communications device 600 may specifically be a non-AP MLD in embodiments of this application, and the communications device 600 may implement corresponding procedures implemented by the non-AP MLD in the methods according to embodiments of this application. For brevity, details are not described herein again.

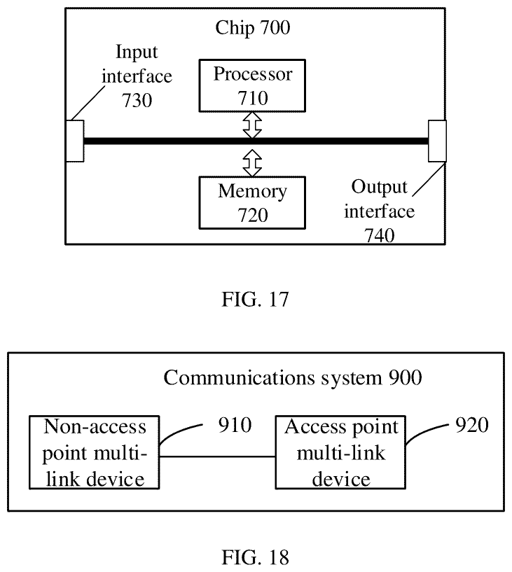

FIG. 17 is a schematic diagram of a structure of a chip according to an embodiment of this application. The chip 700 shown in FIG. 17 includes a processor 710, and the processor 710 may invoke a computer program from a memory and run the computer program to implement a method in embodiments of this application.

Optionally, as shown in FIG. 17, the chip 700 may further include a memory 720. The processor 710 may invoke a computer program from the memory 720 and run the computer program to implement a method in embodiments of this application.

The memory 720 may be a separate component independent of the processor 710, or may be integrated into the processor 710.

Optionally, that the chip 700 may further include an input interface 730. The processor 710 may control the input interface 730 to communicate with another device or chip, and specifically, may obtain information or data sent by the another device or chip.

Optionally, the chip 700 may further include an output interface 740. The processor 710 may control the output interface 740 to communicate with another device or chip, and specifically, may output information or data to the another device or chip.

Optionally, the chip may be applied to an AP MLD in embodiments of this application, and the chip may implement corresponding procedures implemented by the AP MLD in the methods according to embodiments of this application. For brevity, details are not described herein again.

Optionally, the chip may be applied to a non-AP MLD in embodiments of this application, and the chip may implement corresponding procedures implemented by the non-AP MLD in the methods according to embodiments of this application. For brevity, details are not described herein again.

The chip may also be referred to as a system-level chip, a system chip, a chip system, or a system-on-chip, or the like. It should be understood that the chip mentioned in this embodiment of this application may also be referred to as a system-level chip, a system chip, a chip system, or a system on a chip.

FIG. 18 is a schematic block diagram of a communications system 900 according to an embodiment of this application. As shown in FIG. 18, the communications system 900 includes a non-access point multi-link device 910 and an access point multi-link device 920.

The non-access point multi-link device 910 may be configured to implement corresponding functions implemented by a non-AP MLD in the foregoing methods, and the access point multi-link device 920 may be configured to implement corresponding functions implemented by an AP MLD in the foregoing methods. For brevity, details are not described herein again.

It should be understood that, a processor in embodiments of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or perform the methods, steps, and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct Rambus random access memory (DR RAM). It should be noted that, the memory in the systems and methods described in this specification includes but is not limited to these memories and any memory of another proper type.

It should be understood that, by way of example but not limitative description, for example, the memory in this embodiment of this application may alternatively be a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), a direct Rambus random access memory (DR RAM), or the like. In other words, the memory in this embodiment of this application includes but is not limited to these memories and any memory of another proper type.

An embodiment of this application further provides a computer-readable storage medium, configured to store a computer program.

Optionally, the computer-readable storage medium may be applied to an AP MLD in embodiments of this application, and the computer program causes a computer to execute a corresponding procedure implemented by the AP MLD in the methods according to embodiments of this application. For brevity, details are not described herein again.

Optionally, the computer-readable storage medium may be applied to a non-AP MLD in embodiments of this application, and the computer program causes a computer to execute a corresponding procedure implemented by the non-AP MLD in the methods according to embodiments of this application. For brevity, details are not described herein again.

An embodiment of this application further provides a computer program product, which includes computer program instructions.

Optionally, the computer program product may be applied to an AP MLD in embodiments of this application, and the computer program instructions cause a computer to execute a corresponding procedure implemented by the AP MLD in the methods according to embodiments of this application. For brevity, details are not described herein again.

Optionally, the computer program product may be applied to a non-AP MLD in embodiments of this application, and the computer program instructions cause a computer to execute a corresponding procedure implemented by the non-AP MLD in the methods according to embodiments of this application. For brevity, details are not described herein again.

An embodiment of this application further provides a computer program.

Optionally, the computer program may be applied to an AP MLD in embodiments of this application. When the computer program runs on a computer, the computer executes a corresponding procedure implemented by the AP MLD in the methods according to embodiments of this application. For brevity, details are not described herein again.

Optionally, the computer program may be applied to a non-AP MLD in embodiments of this application. When the computer program runs on a computer, the computer executes a corresponding procedure implemented by the non-AP MLD in the methods according to embodiments of this application. For brevity, details are not described herein again.

A person of ordinary skill in the art may be aware that, units and algorithm steps in examples described in combination with embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to corresponding processes in the foregoing method embodiments, and details are not described herein again.

In the several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatus or units may be implemented in electronic, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of embodiments.

In addition, function units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions of embodiments of this application essentially, or the part contributing to the conventional technology, or some of the technical solutions may be implemented in the form of a software product. The computer software product is stored in a storage medium and includes several instructions for instructing a computer device (which may be a personal computer, a server, a network device, or the like) to perform all or some of the steps of the methods described in embodiments of this application. The foregoing storage medium includes various media that may store a program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. A wireless communication method, applied to a non-access point multi-link device (Non-AP MLD), wherein the non-AP MLD comprises at least a first non-AP STA and a second non-AP STA that are affiliated with the non-AP MLD, the first non-AP STA works on a first link, the second non-AP STA works on a second link, and the method comprises:
receiving, by the first non-AP STA on the first link, first information sent by an access point device (AP MLD), wherein the first information comprises at least one piece of target wake time (TWT) parameter information, and the TWT parameter information is used to determine a TWT SP, wherein the at least one piece of TWT parameter information is broadcast TWT (B-TWT) parameter information or restricted TWT (R-TWT) parameter information, and the at least one piece of TWT parameter information corresponds to at least one link.

2. An access point multi-link device (AP MLD), wherein the AP MLD comprises at least a first AP and a second AP that are affiliated with the AP MLD, the first AP works on a first link, the second AP works on a second link, and the AP MLD comprises a processor and a memory, wherein the memory is configured to store a computer program, and the processor is configured to invoke and run the computer program stored in the memory to execute the method comprising:
sending, by the first AP, first information to a non-access point device (non-AP MLD) on the first link, wherein the first information comprises at least one piece of target wake time (TWT) parameter information, and the TWT parameter information is used to determine a TWT SP, wherein the at least one piece of TWT parameter information is broadcast TWT (B-TWT) parameter information or restricted TWT (R-TWT) parameter information, and the at least one piece of TWT parameter information corresponds to at least one link.

3. A non-access point multi-link device (Non-AP MLD), wherein the non-AP MLD comprises at least a first non-AP STA and a second non-AP STA that are affiliated with the non-AP MLD, the first non-AP STA works on a first link, the second non-AP STA works on a second link, and the non-AP MLD comprises a processor and a memory, wherein the memory is configured to store a computer program, and the processor is configured to invoke and run the computer program stored in the memory to execute the method comprising:
receiving, by the first non-AP STA on the first link, first information sent by an access point device (AP MLD), wherein the first information comprises at least one piece of target wake time (TWT) parameter information, and the TWT parameter information is used to determine a TWT SP, wherein the at least one piece of TWT parameter information is broadcast TWT (B-TWT) parameter information or restricted TWT (R-TWT) parameter information, and the at least one piece of TWT parameter information corresponds to at least one link.

4. The non-AP MLD according to claim 3, wherein the first information further comprises first indication information, and the first indication information is used to indicate a target link corresponding to the at least one piece of TWT parameter information.

5. The non-AP MLD according to claim 4, wherein the first indication information indicates, in a bitmap manner, the target link corresponding to the at least one piece of TWT parameter information.

6. The non-AP MLD according to claim 5, wherein the first indication information comprises a first bitmap, the first information comprises first TWT parameter information, the first bitmap corresponds to the first TWT parameter information, the first bitmap comprises a plurality of bits, each bit corresponds to a link ID, and a value of each bit is used to indicate whether the first TWT parameter information is applied to a link indicated by a corresponding link ID.

7. The non-AP MLD according to claim 3, wherein:
the at least one link corresponds to same TWT parameter information; or
the at least one link respectively corresponds to independent TWT parameter information.

8. The non-AP MLD according to claim 3, wherein the AP MLD device comprises a mobile AP MLD device.

9. The non-AP MLD according to claim 8, wherein the first link is a primary link.

10. The non-AP MLD according to claim 3, wherein the at least one link comprises the first link and the second link, the first link is a primary link, and the second link is a secondary link.

11. The non-AP MLD according to claim 10, wherein duration of a TWT SP corresponding to the primary link covers duration of a TWT SP corresponding to the secondary link.

12. The non-AP MLD according to claim 10, wherein a start time of a TWT SP corresponding to the secondary link is the same as a start time of a TWT SP corresponding to the primary link.

13. The non-AP MLD according to claim 10, wherein a start time of a TWT SP corresponding to the secondary link is not earlier than a start time of a TWT SP corresponding to the primary link.

14. The non-AP MLD according to claim 10, wherein an end time of a TWT SP corresponding to the secondary link is not later than an end time of a TWT SP corresponding to the primary link.

15. The non-AP MLD according to claim 3, wherein the at least one piece of TWT parameter information comprises TWT parameter information of a primary link; or
the at least one piece of TWT parameter information comprises TWT parameter information of a primary link and TWT parameter information of at least one secondary link.

16. The non-AP MLD according to claim 3, wherein the first information is carried in a B-TWT element or an R-TWT element in a first frame.

17. The non-AP MLD according to claim 16, wherein the first frame comprises one or more B-TWT elements, and the B-TWT element is used to carry the B-TWT parameter information; or
the first frame comprises one or more R-TWT elements, and the R-TWT element is used to carry the R-TWT parameter information.

18. The non-AP MLD according to claim 16, wherein the B-TWT element comprises a TWT parameter information field, and the TWT parameter information field is used to carry the B-TWT parameter information; or
the R-TWT element comprises a TWT parameter information field, and the TWT parameter information field is used to carry the R-TWT parameter information.

19. The non-AP MLD according to claim 18, wherein the R-TWT element further comprises a link ID bitmap field, and the link ID bitmap field is used to indicate a target link to which the B-TWT parameter information indicated by the TWT parameter information field in the B-TWT element is applied; or
the R-TWT element further comprises a link ID bitmap field, and the link ID bitmap field is used to indicate a target link to which the R-TWT parameter information indicated by the TWT parameter information field in the R-TWT element is applied.

20. The non-AP MLD according to claim 19, wherein the B-TWT element further comprises a control field, the control field comprises a link ID bitmap present field, and the link ID bitmap present field is used to indicate whether the B-TWT element comprises the link ID bitmap field; or
the R-TWT element further comprises a control field, the control field comprises a link ID bitmap present field, and the link ID bitmap present field is used to indicate whether the R-TWT element comprises the link ID bitmap field.
